(19) United States
(12) Patent Application Publication
(10) Pub. No.: US 2006/0110978 A1
(43) Pub. Date: May 25, 2006

(54) Modular power connector

(75) Inventors: Ying-Yi Fan, Taipei (TW); Wen-Zuh Hsieh, Taipei (TW)

Correspondence Address: MICHAEL LIN, 5F 79 Roosevelt Rd. Sec. 2, TAIPEI, 106, TW

(73) Assignee: Powercom Co., Ltd., Taipei Hsien (TW)

(21) Appl. No.: 10/904,704

(22) Filed: Nov. 24, 2004

(51) Int. Cl. H01R 13/648

(52) U.S. Cl. 439/607

(57) ABSTRACT

A modular power connector includes a plurality of insulating blocks consisting of a shielding integrated with a base, conductive plug poles, conductive receptacle poles, a plug shell, and a receptacle shell, wherein each insulating block is furnished on four sides of a base of an insulating block with two pairs of dovetails having first pair of a tenon and a motise on one side and the opposite side of the base of the insulating block, respectively, and a second pair of a tenon and a motise on the adjacent side and the opposite side of the base of the insulating block, respectively.

### BACKGROUND OF THE INVENTION

1. Field of the Invention

The present invention relates to a modular power connector, especially a modular power connector furnished on four sides of a base of an insulating block with two pairs of dovetails having first pair of a tenon and a motise on one side and the opposite side of the base of the insulating block, respectively, and a second pair of a tenon and a motise on the adjacent side and the opposite side of the base of the insulating block, respectively.

2. Description of the Prior Art

Nowadays, there are many high technology electrical machines or electronic devices produced for human aids or entertainments, and power connectors play an important role for supplying electrical power to heavy-duty electrical machineries or electronic devices.

The prior art of a power connector, U.S. Pat. No. 5,248,268, uses fixed numbers of poles for the input of external power supply to electrical machines or electron devices. The power connector with a fixed number of poles may not satisfy requirements of various electrical machines or electronic devices with various numbers of poles. Therefore, the manufacturer of power connectors are sought to provide a power connector with various numbers of poles to fulfill the needs of customers, and it may increase the inventory and the cost of production.

To overcome the shortcomings mentioned above, the present invention tends to provide an improved modular power connector to mitigate the problems aforementioned.

### BACKGROUND OF THE INVENTION

The primary object of the present invention is to provide a modular power connector to be able to assemble with various numbers of poles to meet actual requirements.

Another object of the present invention is to provide a modular power connector including plural insulating blocks to accommodate conductive plug poles or conductive receptacle poles forming a plug or receptacle power connector with a capacity to reduce the inventory and the cost of power connectors.

Another object of the present invention is to provide a modular power connector characterizing in that the insulating blocks are furnished on four sides of a base of an insulating block with two pairs of dovetails enabling the insulating blocks to engage one another to form a modular power connector with various numbers of poles.

To achieve the above objects, a modular power connector in accordance with the present invention includes a plurality of insulating blocks consisting of a shielding integrated with a base, conductive plug poles, conductive receptacle poles, a plug shell, and a receptacle shell, wherein each insulating block has two pairs of dovetail of first pair of tenon a and mortise on one side and the opposite side of the base of the insulating block, respectively, a second pair of a tenon and a motise on the adjacent side and the opposite side of the base of the insulating block, respectively.

Other objects advantages and novel features of the invention will become more apparent from the following detailed description when taken in conjunction with the accompanying drawings.

### BRIEF DESCRIPTION OF THE DRAWINGS

FIG. 1 is an exploded view of receptacle and plug connectors of the modular power connectors of the present invention, respectively;

FIG. 2 is a schematic view showing assembled receptacle and plug connectors of the modular power connectors of the present invention, respectively;

FIG. 3 is an exploded view showing insulating blocks, conductive plug poles, conductive receptacle poles, a plug shell, and a receptacle shell of the modular power connectors of the present invention, respectively; and

FIG. 4 is a schematic view showing completed assemblies of a receptacle and a plug modular power connector of the present invention, respectively.

FIG. 5 is a schematic view showing four faces, top and bottom view of a receptacle power connector of the present invention, respectively.

FIG. 6 is a schematic view showing four faces, top and bottom view of a plug power connector of the present invention, respectively.

### DETAILED DESCRIPTION OF THE PREFERRED EMBODIMENT

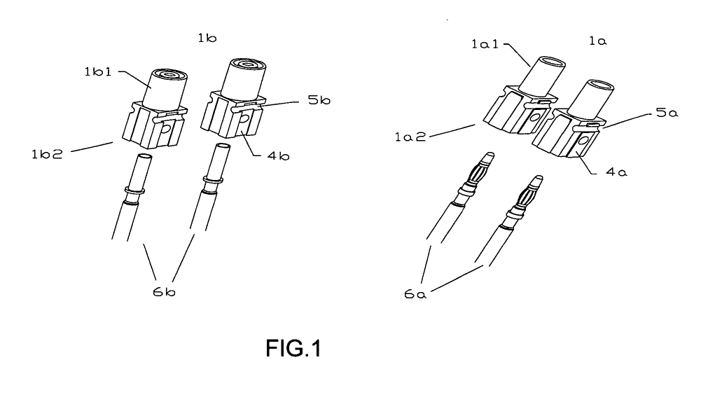

With reference to FIG. 1, the modular power connector in accordance with the present invention includes a plurality of insulating blocks 1a, 1b, consisting of a shielding 1a1, 1b1 integrated with a base 1a2, 1b2, conductive plug poles 6a, conductive receptacle poles 6b, a plug shell 8a, and a receptacle shell 8b, wherein each insulating block 1a, 1b has two pairs of dovetails having first pair of tenon 3a and mortise 3b on one side and the opposite side of the base 1a2, 1b2 of the insulating block 1a, 1b, respectively, a second pair of tenon 4a and mortise 4b on the adjacent side and the opposite side of the base 1a2, 1b2 of the insulating block 1a, 1b, respectively, wherein the tenon 4a and mortise 4b of the second pair are each furnished with a semi-circular slot 5a, 5b near their top ends forming an insertion hole by mating the second tenon 4a of the insulating block with the second mortise 4b of the other insulating block for insertion of a locking pin to fix the insulating block within the shell of a receptacle connector.

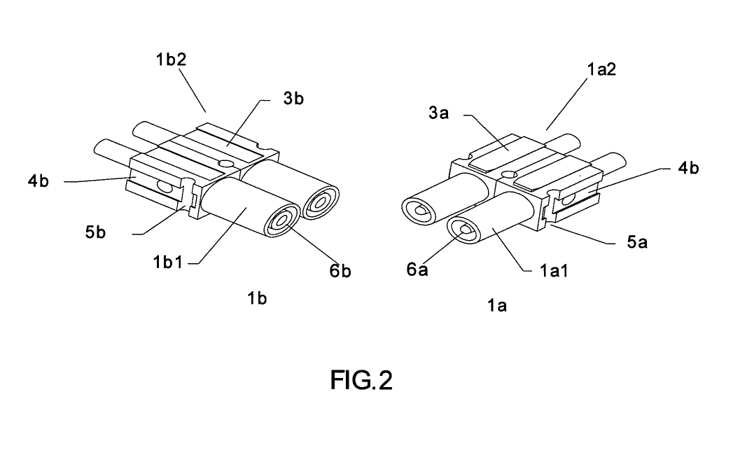

With reference to FIG. 2, two insulating blocks 1a, 1b are firmly assembled by correspondingly mating the tenon and the mortise of respective insulating blocks, and an insertion hole 5 is formed by jointly combining two semi-circular slots 5a, 5b for insertion of a locking pin to fix the assembled insulating blocks within the shell of a receptacle connector, wherein the conductive plug pole 6a and the conductive receptacle pose 6b were inserted through the insulating blocks, respectively.

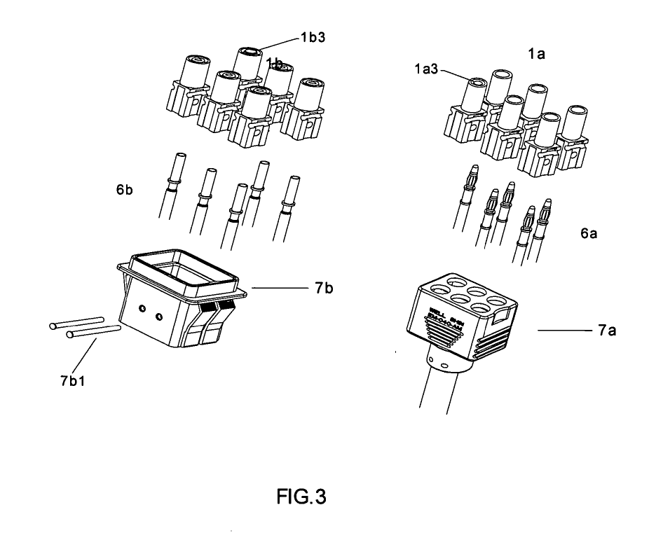

FIG. 3 illustrates an exploded view showing insulating blocks 1a, 1b, conductive plug poles 6a, conductive receptacle poles 6b, a plug shell 7a, a receptacle shell 7b and locking pins 7b1 of the modular power connectors of the present invention, respectively.

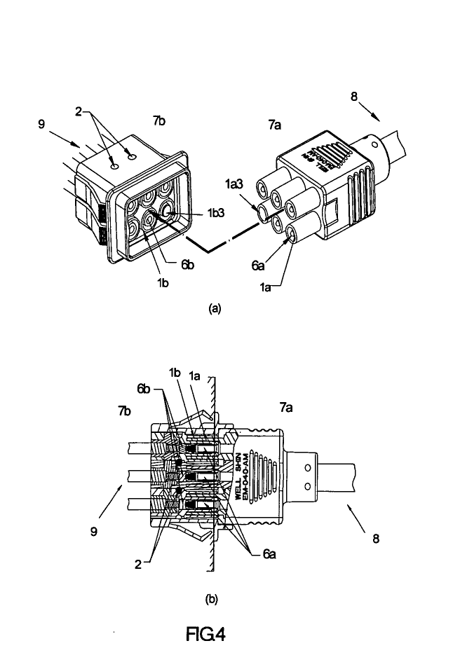

FIG. 4 illustrates a complete assembly of the power connectors of the present invention, wherein six poles of insulating block are assembled in the plug shell 7a and the receptacle shell 7b to make a modular plug connector 8a and a modular receptacle connector 8b, respectively, wherein one of the six poles of each power connector has a fault proof structure 1a3, 1b3 to prevent power connectors from damaging in fault connection.

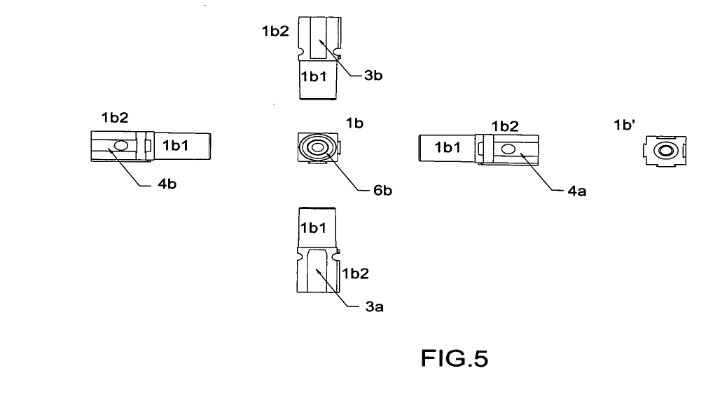

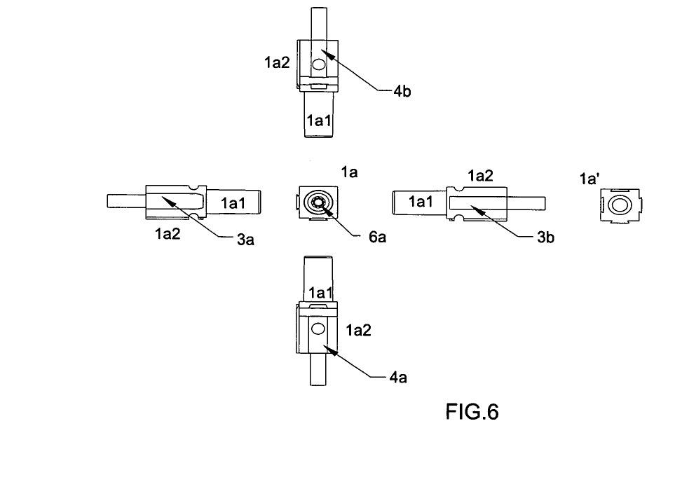

FIG. 5 and FIG. 6 illustrates structures of tenon and mortise of a receptacle and a plug modular power connector of the present invention, respectively.

Various additional modifications of the embodiments specifically illustrated and described herein will be apparent to those skilled in the art, particularly in light of the teachings of this invention. The invention should not be construed as limited to the specific form and examples as shown and described, but instead is set forth in the following claims.

What is claimed is:

1. A modular power connector includes a plurality of insulating blocks consisting of a shielding integrated with a base, conductive plug poles, conductive receptacle poles, a plug shell, and a receptacle shell, wherein the conductive plug poles are inserted in the insulating blocks, followed by assembled within the plug shell, and the conductive receptacle poles are inserted in the insulating blocks, followed by assembled within the receptacle shell, forming a plug type and a receptacle type modular connector, respectively, wherein each insulating block has two pairs of dovetails having first pair of a tenon and a motise on one side and opposite side of the base of the insulating block, respectively, and second pair of a tenon and a motise on adjacent side and opposite side of the base of the insulating block, respectively.

2. The modular power connector as claimed in claim 1, wherein the tenon and the mortise of the second pair are each furnished with a semi-circular slot near their top ends to form an insertion hole by mating the tenon of the second pair of the dovetail of one insulating block with the mortise of the second pair of the dovetail of the other insulating block.

3. The modular power connector as claimed in claim 2, wherein the insertion hole is thus provided for insertion of a locking pin to fix the insulating blocks within the shell of the receptacle connector.
